(19) United States
(12) Patent Application Publication
(10) Pub. No.: US 2025/0193267 A1
(43) Pub. Date: Jun. 12, 2025

(54) DETERMINATION OF MICROSERVICES FROM APPLICATION WEB SERVICES

(71) Applicant: SAP SE, Walldorf (DE)

(72) Inventor: Hui LI, Shanghai (CN)

(21) Appl. No.: 18/530,539

(22) Filed: Dec. 6, 2023

(51) Int. Cl. H04L 67/02; G06F 16/953

(52) U.S. Cl. CPC H04L 67/02; G06F 16/953

(57) ABSTRACT

Systems and methods include identification of a plurality of entities of a monolithic application and navigation relationships between the plurality of entities, determination of a plurality of primary groups of entities based on the navigation relationships and, for each of the plurality of primary groups of entities, determination of a closeness of each entity of the primary group to each other entity of the primary group based on received queries of the navigation relationships between the entities of the primary group, and clustering of the entities of the primary group into two or more secondary groups based on the determined closeness of each entity of the primary group.

### BACKGROUND

Software applications are conventionally “monolithic”, in that their logic is contained within a single logical executable. To make any changes to such an application, a developer must build and deploy an updated version of the entire application. A monolithic application may be executed by a user device or by a server which serves the monolithic application to one or more user devices.

Monolithic applications have been increasingly migrated to the cloud in order to take advantage of the resource elasticity, redundancy, economies of scale and other benefits provided thereby. For example, all monolithic applications executing in a cloud environment share the computing resources (e.g., CPU, memory, and network bandwidth) of the cloud environment. Monolithic applications migrated to the cloud may expose their functionality in the form of Web services.

A microservice provides a discrete set of functions accessible via remote calls. A microservice is executed within a dedicated computing process and can be accessed independently from other microservices. A microservices-based application consists of respective independently-deployed microservices. Each microservice of a microservices-based application may be modified and redeployed independently without redeploying all microservices of the application. Due to the compatibility of a microservices architecture with a cloud environment, it is desirable to convert monolithic applications into microservices-based applications. Such conversion requires identification of groups of Web service entities of an existing monolithic application which are amenable to refactoring into respective microservices.

This identification is currently quite difficult. The Web services of existing monolithic applications may expose hundreds to thousands of entities. Moreover, the entities often exhibit multiple navigation relationships to other entities, thereby exponentially increasing the complexity of the task. Systems are desired to efficiently determine suitable groups of Web service entities of a monolithic application for refactoring into respective microservices.

### BRIEF DESCRIPTION OF THE DRAWINGS

FIG. 1 illustrates a system to determine groups of Web service entities of a monolithic application for refactoring into microservices according to some embodiments.

FIG. 2 is a flow diagram of a process to determine groups of Web service entities of a monolithic application according to some embodiments.

FIG. 3 is a view of an interface to request grouping of Web service entities of a monolithic application according to some embodiments.

FIG. 4 is a view of metadata of monolithic application Web services according to some embodiments.

FIG. 5 is a graph of Web service entities according to some embodiments.

FIG. 6 shows groups of Web service entities according to some embodiments.

FIG. 7 is a tabular representation of counts of queries associated with entity relationships according to some embodiments.

FIG. 8 is a closeness matrix according to some embodiments.

FIG. 9 is a closeness matrix according to some embodiments.

FIG. 10 is a degree matrix according to some embodiments.

FIG. 11 is a Laplacian matrix according to some embodiments.

FIG. 12 shows eigenvectors of a Laplacian matrix according to some embodiments.

FIG. 13 is an affinity matrix according to some embodiments.

FIG. 14 illustrates an output of spectral clustering according to some embodiments.

FIG. 15 is a view of an interface to display and modify groupings of Web service entities according to some embodiments.

FIG. 16 illustrates a cloud-based architecture according to some embodiments.

### DETAILED DESCRIPTION

The following description is provided to enable any person in the art to make and use the described embodiments. Various modifications, however, will remain readily-apparent to those in the art.

Some embodiments facilitate logical grouping of Web service entities of a monolithic application. A respective microservice may be developed for each group of Web service entities in order to refactor the monolithic application into a microservices-based application. Due to the formation of the groups as described herein, the microservices-based application may execute more efficiently than otherwise.

Web service entities represent resources which may be queried/created/edited/deleted using the Web services. In an e-commerce application, metadata may define Web service entities such as Production, Order, Customer, and Delivery entity types. For example:

```
<entityType name=”Production” >
  <property name=”id” type=”int” key=”true”>
    <property name=”name” type=”string”>
    <property name=”description” type=”string”>
    <property name=”price” type=”double”>
</ entityType >
<entityType name=”Customer” >
  <property name=”id” type=”int” key=”true”>
    <property name=”username” type=”string”>
    <property name=”firstname” type=”string”>
    <property name=”lastname” type=”string”>
</ entityType >
<entityType name=”Order” >
  <property name=”id” type=”int” key=”true”>
    <property name=”price” type=”double”>
    <property name=”count” type=”int”>
<property name=”address” type=”string”>
    <property name=”status” type=”string”>
    <Navigation name=”production” toEntity=” Production” >
    <Navigation name=”customer” toEntity=”Customer” >
</ entityType >
<entityType name=”Delivery” >
  <property name=”id” type=”int” key=”true”>
    <property name=”deliveryCompany” type=”String”>
  <property name=”status” type=”string”>
<Navigation name=”order” toEntity=”Order” >
</ entityType >
```

A client system can query the entities of a Web service using HyperText Transfer Protocol (HTTP) methods, i.e.,

| | |
|---|---|
| GET /rest/Production | // to query the list of Productions. |
| GET /rest/Production(123) | // to query Production 123. |
| GET /rest/Order(123) | // to query Order 123. |

| | |
|---|---|
| GET /rest/Order(123)?$expand=production, customer | // to query Order 123 and its |

production, customer information.
GET /rest/Delivery(123)?$expand=order // to query Delivery 123 and its order
information.

| | |
|---|---|
| GET /rest/Delivery(123)?$expand=order/production, order/customer | // to query |

Delivery 123 and its order, production, customer information.

| | |
|---|---|
| POST /rest/Production | //to create a production (requires HTTP request payload) |

POST /rest/Order //to create an order (requires HTTP request payload)

| | |
|---|---|
| PUT /rest/Production(123) | //to update Production 123 (requires HTTP request payload) |
| PUT /rest/Order(123) | //to update Order 123 (requires HTTP request payload) |

| | |
|---|---|
| DELETE /rest/Production(123) | //to delete Production 123 |

| | |
|---|---|
| DELETE /rest/Order(123) | //to delete Order 123 |

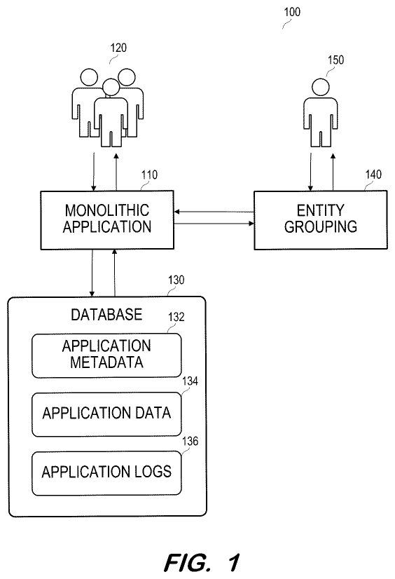

FIG. 1 illustrates system 100 according to some embodiments. The illustrated components of system 100 may be implemented using any suitable combinations of computing hardware and/or software that are or become known. In some embodiments, two or more components are implemented by a single computing device.

The components of system 100 may be on-premise, cloud-based (e.g., in which computing resources are virtualized and allocated elastically), distributed (e.g., with distributed storage and/or compute nodes) and/or deployed in any other suitable manner. Each component may comprise disparate cloud-based services, a single computer server, a cluster of servers, and any other combination that is or becomes known. All or a part of each system may utilize Infrastructure-as-a-Service (IaaS), Platform-as-a-Service (PaaS) and/or Software-as-a-Service (SaaS) offerings owned and managed by one or more different entities as is known in the art.

Monolithic application 110 may comprise executable program code as is known in the art. For example, monolithic application 110 may comprise a single executable file generated by compiling and/or interpreting program code of a high-level programming language. Monolithic application 110 may provide any suitable functionalities to one or more users 120. According to one non-exhaustive example, monolithic application 110 comprises an enterprise resource planning application providing functionalities which may include but are not limited to finance and accounting, supply chain, human resource, procurement, sales, and inventory management.

Monolithic application 110 executes within an application platform (not shown) providing a runtime environment therefor. The application platform may, for example, comprise a single computer server, a virtual machine, or a cluster of computer servers such as a Kubernetes cluster. Kubernetes is an open-source system for automating deployment, scaling and management of containerized applications. Each component of system 100 may therefore be implemented by one or more servers (real and/or virtual) or containers.

Monolithic application 110 provides functionality using data of database 130. Database 130 stores application metadata 132 which defines the entities and data of application 110. For example, application metadata 132 describes entities exposed by Web services of application 110. Application metadata 132 also describes the structure and interrelationships (i.e., the schema) of application data 134. Application data 134 may comprise tables of user data as well as other data used by application 110.

Database 130 may be stored within one or more storage systems, each of which may be standalone or distributed, on-premise or cloud-based. Database 130 may comprise any type of database, data warehouse, object store, or other storage system that is or becomes known.

Users 120 may access monolithic application 110 via a gateway (not shown) which routes requests from users 120 to application 110 and may also provide authentication, authorization, and load balancing. Monolithic application 110 operates to serve the incoming requests. Data describing such operations is stored in application logs 136 as is known in the art. Application logs 136 may include data related to database transactions initiated by application 110, Web service calls received by application 110, and the like.

Entity grouping component 140 may comprise a service and/or application. Entity grouping component 140 may communicate with monolithic application 110 (and/or directly with database 130) to acquire application metadata 132. For example, entity grouping component 140 may acquire metadata 132 describing the entities of Web services of application 110. Entity grouping component 140 may use the acquired metadata 132 to determine groups of Web service entities according to some embodiments. Entity grouping component 140 may be executed by the same application platform as monolithic application 110 or by a different application platform. In some embodiments, administrator 150 accesses a Web page hosted by entity grouping component 140 to specify a monolithic application and to request groupings of Web service entities thereof.

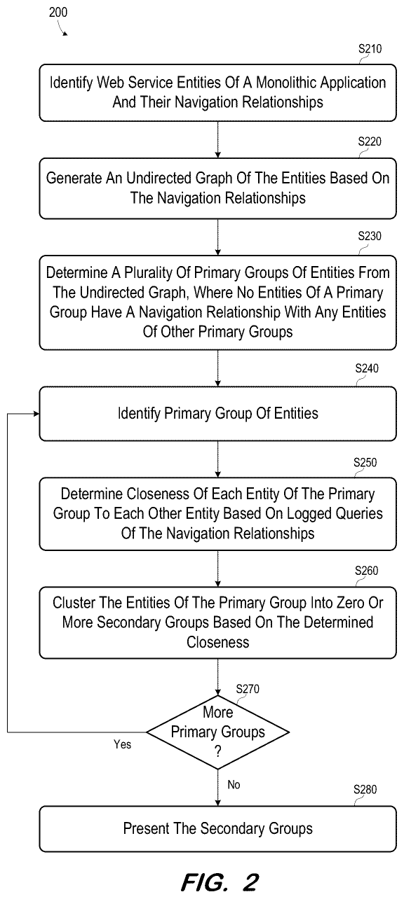

FIG. 2 is a flow diagram of process 200 to determine groups of Web service entities of a monolithic application according to some embodiments. Process 200 and the other processes described herein may be performed using any suitable combination of hardware and software. Software program code embodying these processes may be stored by any non-transitory tangible medium, including a fixed disk, a volatile or non-volatile random access memory, a DVD, a Flash drive, or a magnetic tape, and executed by any number of processing units, including but not limited to processors, processor cores, and processor threads. Such processors, processor cores, and processor threads may be implemented by a virtual machine provisioned in a cloud-based architecture. Embodiments are not limited to the examples described below.

Initially, at S210, Web service entities of a monolithic application and their navigation relationships are identified. S210 may comprise acquisition of metadata describing the entities and navigation relationships. In one non-exhaustive example of S210, an administrator operates a device (e.g., a desktop computer) to launch a Web browser application. The administrator inputs a Uniform Resource Locator (URL) associated with an entity grouping application, causing the Web browser to send a request to a cloud gateway corresponding to the URL. The gateway may perform authentication/authorization and forward the request to the entity grouping application, after which the entity grouping application returns a Web page to the Web browser for display thereby.

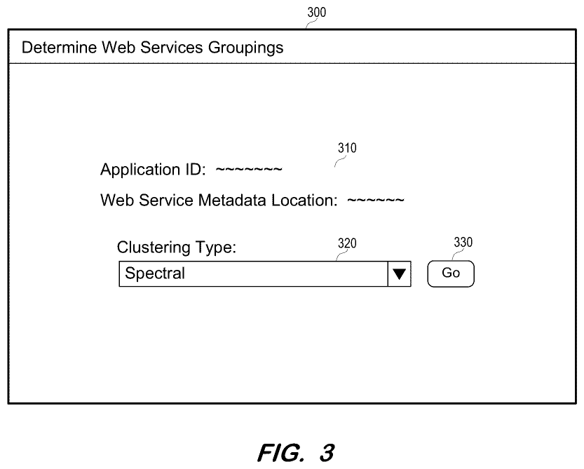

FIG. 3 is a view of interface 300 to request grouping of Web service entities of a monolithic application according to some embodiments. Interface 300 may comprise a Web page returned by an entity grouping application as described above. Interface 300 includes information 310 identifying a monolithic application and a location of the Web service metadata of the monolithic application. Information 310 may be determined using any suitable technique and may include data usable to access the Web service metadata of the monolithic application.

Drop-down menu 320 allows an administrator to specify a type of clustering to be applied during grouping of the Web service entities as will be described below. Types of clustering include but are not limited to Spectral, K-means, Hierarchical and Fuzzy. According to some embodiments, the type of clustering is not selectable by an administrator. Selection of control 330 causes retrieval of the Web service metadata identified by information 310.

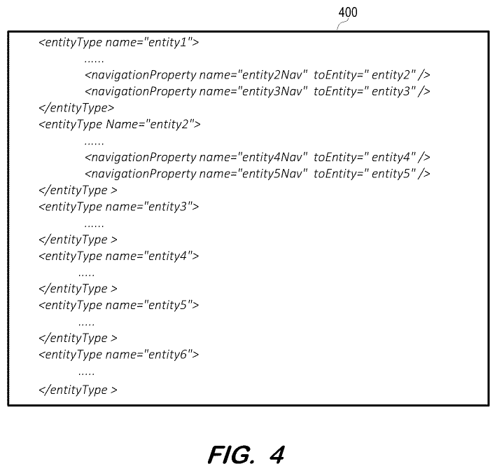

FIG. 4 is a view of metadata 400 of Web services of a monolithic application according to some embodiments. Metadata 400 may be retrieved from a monolithic application or directly from a data storage system which stores metadata 400. Metadata 400 may comprise a portion of application metadata 132 described above.

As shown in FIG. 4, entity1 has navigation relationships (i.e., per “navigationProperty”) to entity2 and entity3, and entity2 has navigation relationships to entity4 and entity5. A user of the corresponding monolithic application can therefore query entity1, entity2, entity3, entity4, entity5 using the expand expression “/odata/v2/entity1?$expand=entity2Nav/entityNav4, entity2Nav/entityNav5, entityNav3” in one call to a Web service Application Programming Interface (API).

At S220, an undirected graph of the entities is generated based on the navigation relationships. The undirected graph includes one vertex for each entity, and the edges of the undirected graph represent the navigation relationships among the entities. FIG. 5 is an example of undirected graph 500 of Web service entities generated at S220 according to some embodiments.

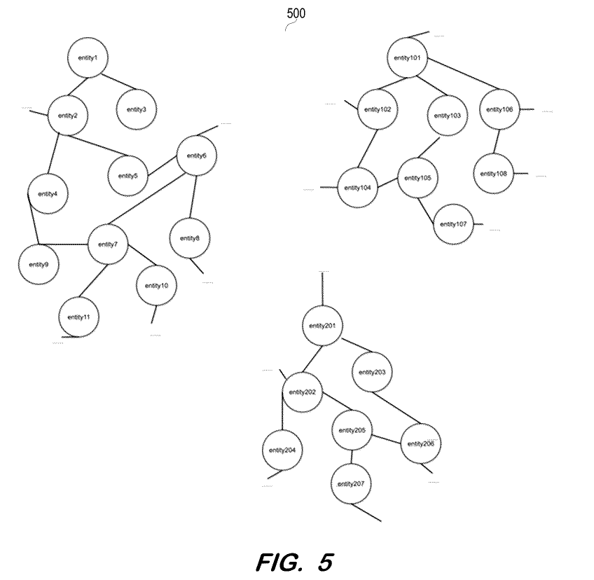

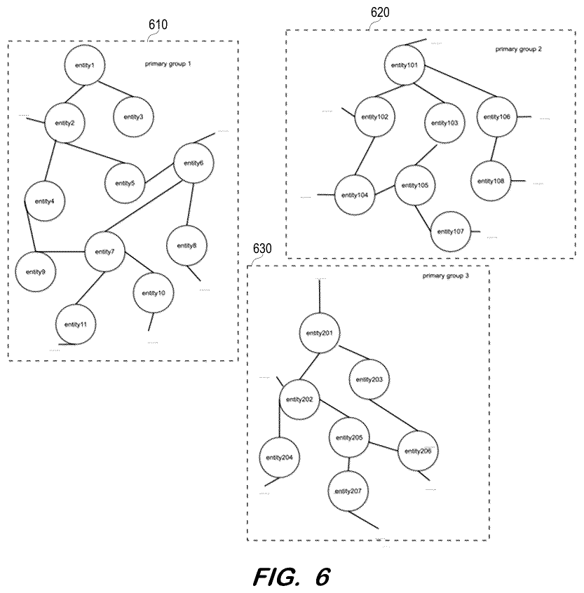

Next, at S230, a plurality of primary groups of entities are determined from the undirected graph, where no entities of a primary group have a navigation relationship (i.e., a shared edge) with any entities of other primary groups. In some embodiments, the undirected graph is searched by a depth-first or breadth-first search algorithm to identify entities which are linked to one another directly or via one or more intermediate navigation relationships. FIG. 6 shows three primary groups 610, 620 and 630 of Web service entities generated from undirected graph 500 at S230 according to some embodiments.

It is expected that the number of entities of at least one primary group will be too large to be included within one microservice. Accordingly, S240-S270 are executed to generate secondary groups of one or more of the primary groups. One of the primary groups of entities is identified at S240. Next, a closeness of each entity of the identified primary group to each other entity of the primary group is determined at S250 based on logged queries of the navigation relationships.

S250 may include acquisition of access logs of Web services which query the relationships among different entities. The acquired access logs may represent queries executed by the monolithic application over a given time period, for example over several months. The number of queries of each relationship between two entities is counted from the logs. According to some embodiments, the relationship from entity1 to entity2 and the relationship from entity2 to entity1 is treated as the same relationship.

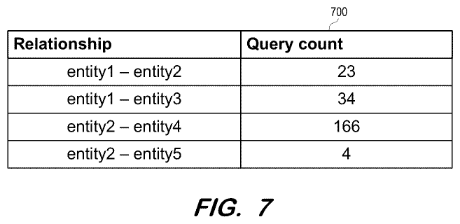

Table 700 of FIG. 7 shows the number of queries counted from the access logs for each of four entity relationships within a primary group of entities. Given the logged query “/odata/v2/entity1?$expand=entity2Nav/entityNav4, entity2Nav/entityNav5,entityNav3”, for example, the count associated with each of the relationships shown in table 700 is incremented by 1.

Based on the query counts determined for each relationship, the closeness c_{i,j} between every two entities entity; and entity; may be determined as:

$${c}_{i , j} = \{ \begin{matrix}0 , & i = j \\ \frac{{queryCount}_{i , j}}{{queryCount}_{max}} , & i \neq j\end{matrix}$$

where queryCount_{i,j} is the query count of the relationship between entity; and entityⱼ, queryCountₘₐₓ is the maximum query count among all the relationships. The value scope of c_{i,j} is [0, 1] and is c_{i,j}=c_{j,i}. FIG. 8 illustrates generic closeness matrix 800 of c_{i,j} according to some embodiments.

The entities of the primary group are then clustered into zero or more secondary groups based on the determined closeness at S260. According to some embodiments, the clustering algorithm allows the number of secondary groups to be configured. The following description is an example of spectral clustering according to some embodiments.

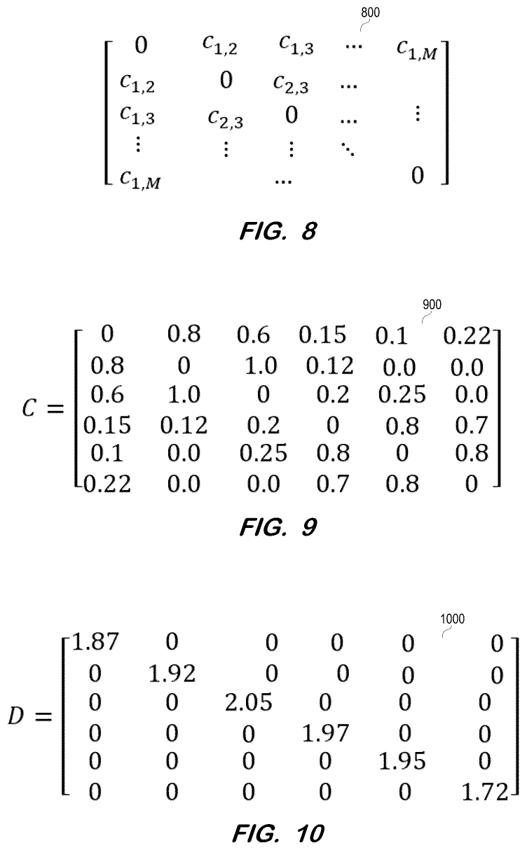

FIG. 9 illustrates closeness matrix 900 for a primary group of six entities e1 through e6. Assuming that the entities are to be divided into two secondary groups (per the above-mentioned configuration, for example), a degree matrix is computed from the closeness matrix. Determination of the degree matrix includes summing each column of closeness matrix 900 and placing the sums on the diagonal of a matrix as shown in the example of degree matrix 1000 of FIG. 10.

A Laplacian matrix L is determined based on the difference between the degree matrix D and the closeness matrix C, such that L=D-C. FIG. 11 is a view of Laplacian matrix 1100 determined based on closeness matrix 900 and degree matrix 1000 of the present example according to some embodiments.

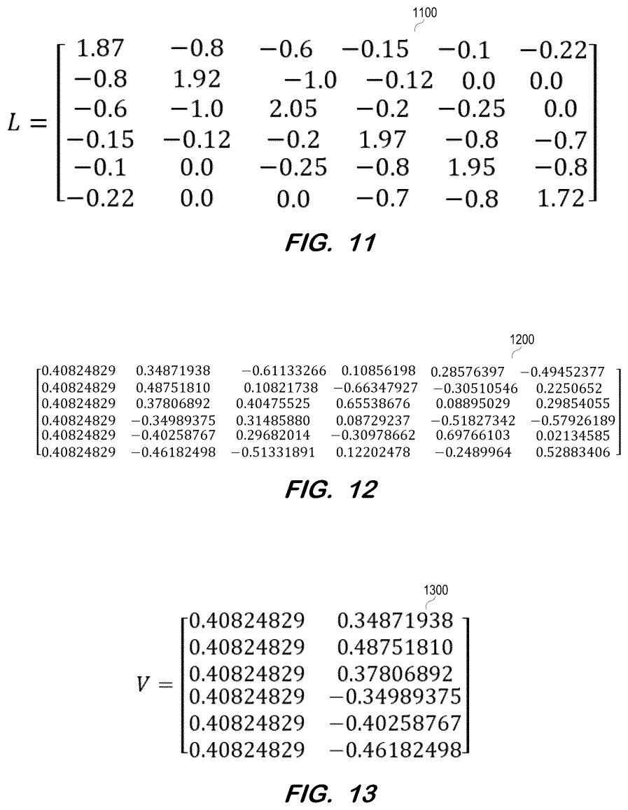

The eigenvalues and eigenvectors of the Laplacian matrix are then determined. With respect to Laplacian matrix 1100 of FIG. 11, the eigenvalues are [0,0.658,2.349,3.054,2.756,2.660]. The corresponding eigenvectors of Laplacian matrix 1100 are shown in matrix 1200 of FIG. 12.

Next, an affinity matrix Vis generated based on the eigenvectors of the Laplacian matrix. The matrix V is equal to N×K, where K is the number of secondary entity groups to be formed. Matrix V is formed by the K eigenvectors associated with the K smallest eigenvalues of the Laplacian matrix.

Assuming K=2, the affinity matrix V is formed using the two eigenvectors associated with the two smallest eigenvalues. The two smallest eigenvalues in the present example are 0 and 0.658. Since these eigenvalues are the first two eigenvalues, the first and the second eigenvectors of matrix 1200 are used to form affinity matrix 1300 of FIG. 13.

The element (v_{i,0}, v_{i,1}) of affinity matrix 1300 represents the compressed representation of the i-th data point in two-dimensional space. That is, in two 2-dimensional space, e1 is at position (0.40824829, 0.34871938), e2 is at position (0.40824829, 0.4875181), e3 is at position (0.40824829, 0.37806892), e4 is at position (0.40824829,−0.34989375), e5 is at position (0.40824829, −0.40258767), and e6 is at position (0.40824829, −0.46182498).

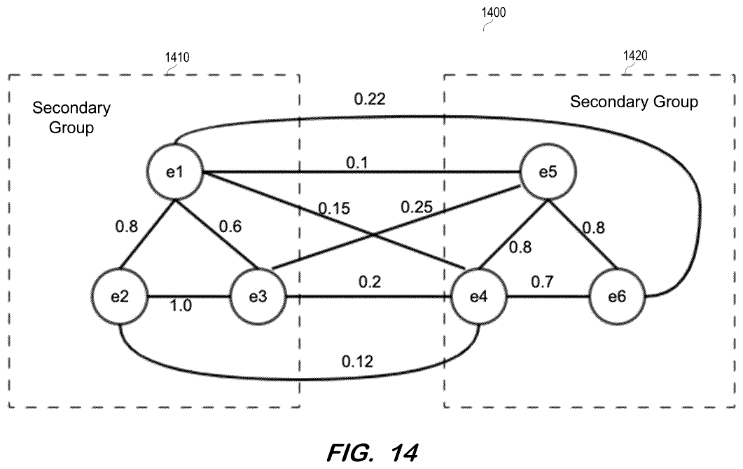

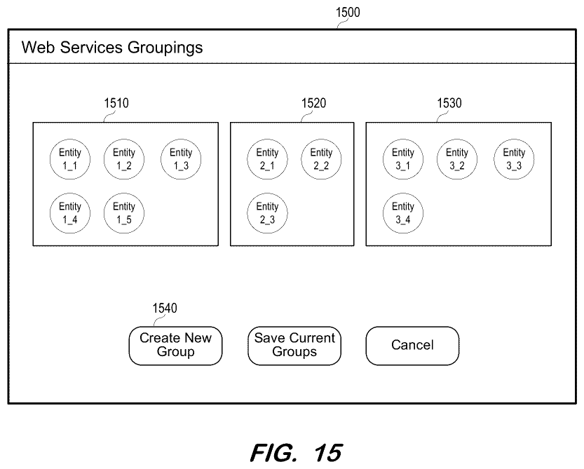

K-means clustering is then applied to matrix V to group similar data points. Since the i-th row of matrix V represents the compressed representation of the i-th data point in K-dimensional space, the data points are particularly amenable to grouping using K-means clustering. Matrix 1300 is grouped into two groups using K-means clustering, with rows (0, 1, 2) of matrix 1300 being in one group, and rows (3, 4, 5) of matrix 1300 being in another group. FIG. 14 shows clustered graph 1400 of a primary group of an undirected graph including entities e1 through e6 grouped into secondary groups 1410 and 1420. The edges between entities are labeled with their associated closeness values as described above.

At S270, it is determined whether another primary group of the plurality of primary groups of entities remain to be processed. If so, flow returns to S240 and continues as described above to determine zero or more secondary groups of entities from another primary group. Flow proceeds from S270 to S280 once each of the plurality of primary groups is processed.

All of the determined secondary groups of entities are presented at S280. If no secondary groups are determined for a primary group, that primary group may also be presented at S280. Embodiments may also indicate the primary groups from which each secondary group was formed.

FIG. 15 is a view of interface 1500 to display and modify groupings of Web service entities according to some embodiments. Interface 1500 may be presented to an administrator at S280. Interface 1500 shows entity groups 1510, 1520 and 1530. Interface 1500 may allow the administrator to drag and drop entities from one group to another group. In this regard, Create New Group control 1540 may be selected to create a new group into which one or more of the presented entities may be dragged and dropped. As described above, and to assist in refactoring a monolithic application including the Web service entities of interface 1500, a respective microservice may be developed for each of groupings 1510, 1520 and 1530. The microservice developed for a grouping of entities exposes each entity of the grouping.

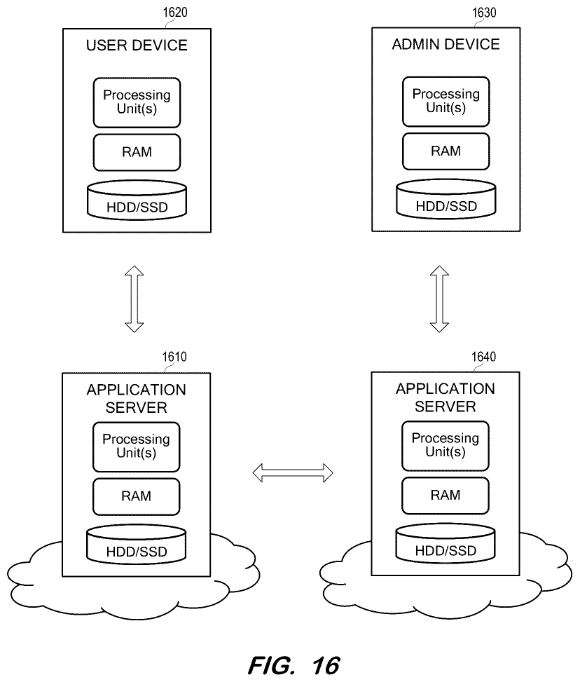

FIG. 16 illustrates a cloud-based database deployment according to some embodiments. User device 1610 may comprise a local computing system operated by a user to access functionality of a user application executed by application server 1620. Administrator device 1630 may comprise a local computing system operated by an administrator to access an entity grouping application executed by application server 1640. The entity grouping application may determine groupings of Web service entities of the user application based on application metadata and access logs stored in application server 1620.

Either of application servers 1620 and 1640 may comprise cloud-based resources residing in one or more public clouds providing self-service and immediate provisioning, autoscaling, security, compliance and identity management features. Servers 1620 and 1640 may comprise servers or virtual machines of respective Kubernetes clusters, but embodiments are not limited thereto.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a hard disk, a DVD-ROM, a Flash drive, magnetic tape, and solid state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

What is claimed is:

1. A system comprising:
memory storing processor-executable program code; and
a processing unit to execute the processor-executable program code to cause the system to:
identify a plurality of entities of an application and navigation relationships between the plurality of entities;
determine a plurality of primary groups of entities based on the navigation relationships, where no entities of a primary group have a navigation relationship with any entities of another primary group;
for each of the plurality of primary groups of entities:
determine a closeness of each entity of the primary group to each other entity of the primary group based on received queries of the navigation relationships between the entities of the primary group; and
cluster the entities of the primary group into two or more secondary groups based on the determined closeness of each entity of the primary group; and
present the secondary groups.

2. The system according to claim 1, where the entities are Web service entities, and wherein the plurality of entities and navigation relationships between the plurality of entities are identified from metadata associated with the application.

3. The system according to claim 1, wherein determination of the closeness of each entity of a primary group to each other entity of the primary group comprises:
counting a number of the received queries for each of the navigation relationships between the entities of the primary group to determine closeness values c_{i,j} between every two entities entityᵢ and entityⱼ of the primary group, where c_{i,j}=c_{j,i}.

4. The system according to claim 3, wherein the queries are received from a plurality of users of the application.

5. The system of claim 3, wherein clustering of the entities of the primary group into two or more secondary groups comprises:
generation of a closeness matrix of the closeness values c_{i,j};
summing of each column of the closeness matrix and forming of a degree matrix including the summed values on a diagonal of the degree matrix;
generation of a Laplacian matrix based on a difference between the degree matrix and the closeness matrix;
determination of eigenvectors of the Laplacian matrix;
determination of an affinity matrix based on the Laplacian matrix and a desired number of secondary groups, where each row of the affinity matrix represents an entity of the primary group; and
clustering of the rows of the affinity matrix into the desired number of secondary groups.

6. The system of claim 1, wherein clustering of the entities of the primary group into two or more secondary groups comprises:
generation of a closeness matrix of the closeness c_{i,j} between every two entities entityᵢ and entity; of the primary group, where c_{i,j}=c_{j,i};
summing of each column of the closeness matrix and forming of a degree matrix including the summed values on a diagonal of the degree matrix;
generation of a Laplacian matrix based on a difference between the degree matrix and the closeness matrix;
determination of eigenvectors of the Laplacian matrix;
determination of an affinity matrix based on the Laplacian matrix and a desired number of secondary groups, where each row of the affinity matrix represents an entity of the primary group; and
clustering of the rows of the affinity matrix into the desired number of secondary groups.

7. A method comprising:
identifying a plurality of entities of a monolithic application and navigation relationships between the plurality of entities;
determining a plurality of primary groups of entities based on the navigation relationships, where no entities of a primary group have a navigation relationship with any entities of another primary group;
for each of the plurality of primary groups of entities:
determining a closeness of each entity of the primary group to each other entity of the primary group based on received queries of the navigation relationships between the entities of the primary group; and
clustering the entities of the primary group into two or more secondary groups based on the determined closeness of each entity of the primary group; and
presenting the secondary groups.

8. The method according to claim 7, where the entities are Web service entities, and wherein the plurality of entities and navigation relationships between the plurality of entities are identified from metadata associated with the application.

9. The method according to claim 7, wherein determining the closeness of each entity of a primary group to each other entity of the primary group comprises:
counting a number of the received queries for each of the navigation relationships between the entities of the primary group to determine closeness values c_{i,j} between every two entities entityᵢ and entityⱼ of the primary group, where c_{i,j}=c_{j,i}.

10. The method according to claim 9, wherein the queries are received from a plurality of users of the application.

11. The method of claim 9, wherein clustering the entities of the primary group into two or more secondary groups comprises:
generating a closeness matrix of the closeness values c_{i,j};
summing each column of the closeness matrix and forming of a degree matrix including the summed values on a diagonal of the degree matrix;
generating a Laplacian matrix based on a difference between the degree matrix and the closeness matrix;
determining eigenvectors of the Laplacian matrix;
determining an affinity matrix based on the Laplacian matrix and a desired number of secondary groups, where each row of the affinity matrix represents an entity of the primary group; and
clustering the rows of the affinity matrix into the desired number of secondary groups.

12. The method of claim 7, wherein clustering the entities of the primary group into two or more secondary groups comprises:
generating a closeness matrix of the closeness c_{i,j} between every two entities entityᵢ and entityⱼ of the primary group, where c_{i,j}=c_{j,i};
summing each column of the closeness matrix and forming of a degree matrix including the summed values on a diagonal of the degree matrix;
generating a Laplacian matrix based on a difference between the degree matrix and the closeness matrix;
determining eigenvectors of the Laplacian matrix;
determining an affinity matrix based on the Laplacian matrix and a desired number of secondary groups, where each row of the affinity matrix represents an entity of the primary group; and
clustering the rows of the affinity matrix into the desired number of secondary groups.

13. A non-transitory computer-readable medium storing processor-executable program code, the program code executable to cause a system to:
identify a plurality of entities of a monolithic application and navigation relationships between the plurality of entities;
determine a plurality of primary groups of entities based on the navigation relationships;
for each of the plurality of primary groups of entities:
determine a closeness of each entity of the primary group to each other entity of the primary group based on received queries of the navigation relationships between the entities of the primary group; and
cluster the entities of the primary group into two or more secondary groups based on the determined closeness of each entity of the primary group; and
present the secondary groups.

14. The medium according to claim 13, where the entities are Web service entities, and wherein the plurality of entities and navigation relationships between the plurality of entities are identified from metadata associated with the application.

15. The medium according to claim 13, wherein determination of the closeness of each entity of a primary group to each other entity of the primary group comprises:
counting a number of the received queries for each of the navigation relationships between the entities of the primary group to determine closeness values c_{i,j} between every two entities entityᵢ and entityⱼ of the primary group, where c_{i,j}=c_{j,i}.

16. The medium according to claim 15, wherein the queries are received from a plurality of users of the application.

17. The medium of claim 15, wherein clustering of the entities of the primary group into two or more secondary groups comprises:
generation of a closeness matrix of the closeness values c_{i,j};
summing of each column of the closeness matrix and forming of a degree matrix including the summed values on a diagonal of the degree matrix;
generation of a Laplacian matrix based on a difference between the degree matrix and the closeness matrix;
determination of eigenvectors of the Laplacian matrix;
determination of an affinity matrix based on the Laplacian matrix and a desired number of secondary groups, where each row of the affinity matrix represents an entity of the primary group; and
clustering of the rows of the affinity matrix into the desired number of secondary groups.

18. The medium of claim 13, wherein clustering of the entities of the primary group into two or more secondary groups comprises:
generation of a closeness matrix of the closeness c_{i,j} between every two entities entity;
and entityⱼ of the primary group, where c_{i,j}=c_{j,i};
summing of each column of the closeness matrix and forming of a degree matrix including the summed values on a diagonal of the degree matrix;
generation of a Laplacian matrix based on a difference between the degree matrix and the closeness matrix;
determination of eigenvectors of the Laplacian matrix;
determination of an affinity matrix based on the Laplacian matrix and a desired number of secondary groups, where each row of the affinity matrix represents an entity of the primary group; and
clustering of the rows of the affinity matrix into the desired number of secondary groups.
